(19) United States
(12) Patent Application Publication
(10) Pub. No.: US 2026/0201862 A1
(43) Pub. Date: Jul. 16, 2026

(54) A WIND TURBINE BLADE

(71) Applicant: Vestas Wind Systems A/S, Aarhus N. (DK)

(72) Inventors: Søren Steffensen, Brabrand (DK); Peter Bøttcher, Egå (DK); Mohammed Fajar, Hinnerup (DK); Nils Martin, Horsens (DK)

(73) Assignee: Vestas Wind Systems A/S, Aarhus N. (DK)

(21) Appl. No.: 19/141,115

(22) PCT Filed: Dec. 18, 2023
(86) PCT No.: PCT/DK2023/050318

§ 371 Date: Jun. 19, 2025

(30) Foreign Application Priority Data
Dec. 21, 2022 (DK) PA202270641

(51) Int. Cl. F03D 1/06

(52) U.S. Cl. CPC F03D 1/0677; F05B 2250/12

(57) ABSTRACT

A first aspect of the invention provides a wind turbine blade comprising an inboard wind turbine blade portion and an outboard wind turbine blade portion for joining together by a joint, each of the inboard and outboard wind turbine blade portions having an end with an aerofoil profile, wherein the aerofoil profile has both concave and convex geometric portions, the end of each of the respective wind turbine blade portions having a plurality of inserts embedded therein, each insert comprising an end portion having a connection for coupling the insert to another of the inserts across the joint and an extension portion which extends away from the end portion to a tip, wherein the plurality of inserts of one of the respective wind turbine blade portions includes: at least one first insert; and at least one second insert, wherein the first insert has a geometry different than a geometry of the second insert.

### FIELD OF THE INVENTION

The present invention relates to a wind turbine blade.

### BACKGROUND OF THE INVENTION

Wind turbine blades are subject to various loads. The loads typically include aerodynamic forces generated by the wind, including air pressure on the blades, changing wind speed and direction, as well as loads originating from the dead weight of the blade itself.

There is a continued drive to produce larger wind turbine blades, due to the increased energy production that is produced. Yet, as the size of wind turbine blades continues to increase, wind turbine blades may become more complex to transport, at least onshore. It has become desirable to manufacture and transport blades as separate portions and to construct the blades on a site closer to the wind turbine by connecting the blade portions. An adjacent pair of blade portions may have a plurality of inserts embedded in the end of each of the respective blade portions, each insert used to couple to another insert of the other of the pair of blade portions to form the connection between the blade portions. The loads across the connected blade portions can be great for a large wind turbine blade and so it is an aim to improve the joint between the blade portions.

### SUMMARY OF THE INVENTION

A first aspect of the invention provides a wind turbine blade comprising an inboard wind turbine blade portion and an outboard wind turbine blade portion for joining together by a joint, each of the inboard and outboard wind turbine blade portions having an end with an aerofoil profile, wherein the aerofoil profile has both concave and convex geometric portions, the end of each of the respective wind turbine blade portions having a plurality of inserts embedded therein, each insert comprising an end portion having a connection for coupling the insert to another of the inserts across the joint and an extension portion which extends away from the end portion to a tip, wherein the plurality of inserts of one of the respective wind turbine blade portions includes:
at least one first insert; and
at least one second insert,
   wherein the first insert has a geometry different than a geometry of the second insert.

Each insert may have an end portion with peripheral faces which define a cross-section. The peripheral faces of the first insert may define a first cross-section. The peripheral faces of the second insert may define a second cross-section. The first cross-section may have a geometry different than a geometry of the second cross-section.

The first and/or second cross-sections may be generally quadrilateral.

The first and/or second cross-sections may be generally trapezoidal, rectangular or square.

The first cross-section may be larger than the second cross-section.

The peripheral faces of each of the plurality of inserts may include an end portion inner face towards an interior of the wind turbine blade portion, an end portion outer face towards an exterior of the wind turbine blade portion, and a pair of end portion side faces.

The end portion outer face may be wider or narrower or the same width as the end portion inner face.

Each end portion side face may be a substantially planar facet.

The extension portion of each of the plurality of inserts may include an extension portion inner face towards an interior of the wind turbine blade portion, an extension portion outer face towards an exterior of the wind turbine blade portion, and a pair of extension portion side faces. The extension portion inner face may meet with the end portion inner face. The extension portion outer face may meet with the end portion outer face. The extension portion side faces may meet with the end portion side faces. A height between the extension portion inner face and the extension portion outer face may reduce as it extends away from the end portion.

The height may reduce uniformly as the extension portion extends away from the end portion.

The extension portion inner face and/or the extension portion outer face may be planar. Adjacent peripheral faces of adjacent inserts may be oriented normal to the circumference of the aerofoil profile at the end of the respective wind turbine blade portion.

The plurality of inserts may be arranged side by side around at least a portion of a circumference of the aerofoil profile at the end of the respective wind turbine blade portion. The plurality of inserts arranged side by side may have gaps therebetween, and the gaps may be filled with other blade material, such as glass fibre.

Each respective wind turbine blade portion may have a leading edge, a trailing edge, a leeward side extending between the leading edge and the trailing edge and a windward side extending between the leading edge and the trailing edge. The plurality of inserts may be provided in groups, with a first group of inserts on the leeward side near a thickest part of the aerofoil profile, a second group of inserts on the windward side near the thickest part of the aerofoil profile, a third group of inserts near the trailing edge on the windward side and a fourth group of inserts near the trailing edge on the leeward side.

The inserts of the first and/or second groups of inserts may have a greater depth between their end portion inner face and their end portion outer face than the inserts of the third and/or fourth groups of inserts.

The end portion of at least one of the inserts may have a bushing with a threaded bore for receiving a threaded fastener.

The threaded fastener may form the connection for joining the wind turbine blade portions together.

At least one of the plurality of inserts may have a threaded bore diameter different than a threaded bore diameter of another of the plurality of inserts.

At least one of the plurality of inserts may have a size different than a size of another of the plurality of inserts.

The plurality of inserts may be sandwiched between fibre reinforced composite layers forming a shell of the wind turbine blade.

According to a second aspect, a wind turbine blade comprises an inboard wind turbine blade portion and an outboard wind turbine blade portion for joining together by a joint, each of the inboard and outboard wind turbine blade portions having an end, the end of each of the respective wind turbine blade portions having a plurality of inserts embedded therein, each insert comprising an end portion having a connection for coupling the insert to another of the inserts across the joint and an extension portion which extends away from the end portion to a tip. The joint may comprise a joint member between the inboard wind turbine blade portion and the outboard wind turbine blade portion. The end portion of at least one of the inserts may have a bushing with a threaded bore which receives a threaded fastener projecting from an end face of the insert opposite the tip. The joint member may have a flange with a first face and a second face opposing the first face and a through hole between the first face and the second face. The first face may be abutting the end face of the insert. The first and second faces of the joint member may be non-parallel such that the second face is normal to a longitudinal axis of the threaded fastener. The second aspect may be combined with the first aspect.

According to a third aspect, a wind turbine blade comprises an inboard wind turbine blade portion and an outboard wind turbine blade portion for joining together by a joint. has an inboard wind turbine blade portion and an outboard wind turbine blade portion joined together by a joint, each of the inboard and outboard wind turbine blade portions having an end, the end of each of the respective wind turbine blade portions having a plurality of inserts embedded therein, wherein the end portion of at least one of the inserts has a bushing with a threaded bore for receiving a threaded fastener. The threaded fastener may have a first threaded end received in the threaded bore of the insert, a second threaded end for receiving a nut, and a shank between the first threaded end and the second threaded end. The shank may have a solid non-circular cross-section with a major dimension generally aligned with a circumference of the end of the wind turbine blade portion, and a minor dimension generally perpendicular to the major dimension. This third aspect may be combined with the first aspect and/or the second aspect.

### BRIEF DESCRIPTION OF THE DRAWINGS

Embodiments of the invention will now be described with reference to the accompanying drawings, in which:

FIG. 1 shows a front view of a wind turbine;

FIG. 2 shows an isometric view of a wind turbine blade;

FIG. 3 shows a profile view of a blade portion;

FIG. 4 shows a detailed view of a joint connecting two blade portions;

FIG. 5 shows a magnified view of area A in FIG. 3;

FIG. 6 shows a magnified view of area B in FIG. 3;

FIG. 7 shows an isometric view of an insert;

FIGS. 8A to 8D show profile views of four inserts with differing geometries;

FIG. 9 shows an isometric view of a blank body for forming inserts;

FIG. 10 shows a schematic representation of a portion of the joint; and

FIGS. 11A to 11C show isometric, side and plan views of a threaded fastener.

### DETAILED DESCRIPTION OF EMBODIMENT(S)

In this specification, terms such as leading edge, trailing edge, pressure surface, suction surface, thickness, and chord are used. While these terms are well known and understood to a person skilled in the art, definitions are given below for the avoidance of doubt.

The term leading edge is used to refer to an edge of the blade which will be at the front of the blade as the blade rotates in the normal rotation direction of the wind turbine rotor.

The term trailing edge is used to refer to an edge of a wind turbine blade which will be at the back of the blade as the blade rotates in the normal rotation direction of the wind turbine rotor.

The chord of a blade is the straight line distance from the leading edge to the trailing edge in a given cross section perpendicular to the blade spanwise direction. The term chordwise is used to refer to a direction from the leading edge to the trailing edge, or vice versa.

A pressure surface (or windward surface) of a wind turbine blade is a surface between the leading edge and the trailing edge, which, when the blade is in use, has a higher pressure than a suction surface of the blade.

A suction surface (or leeward surface) of a wind turbine blade is a surface between the leading edge and the trailing edge, which will have a lower pressure acting upon it than that of a pressure surface, when the blade is in use.

The thickness of a wind turbine blade is measured perpendicularly to the chord of the blade and is the greatest distance between the pressure surface and the suction surface in a given cross section perpendicular to the blade spanwise direction.

The term spanwise is used to refer to a direction from a root end of a wind turbine blade to a tip end of the blade, or vice versa. When a wind turbine blade is mounted on a wind turbine hub, the spanwise and radial directions will be substantially the same.

In this context the geometry of the insert is used to refer to a size, shape, and/or orientation (with respect the periphery of the aerofoil profile of the blade).

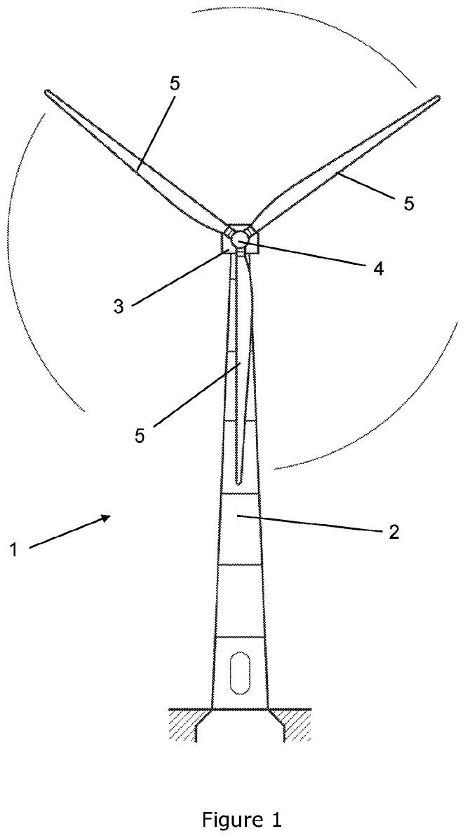

FIG. 1 shows a wind turbine 1 according to an example. The wind turbine 1 includes a tower 2 and a nacelle 3 mounted on the tower 2. A hub 4 is mounted rotatably on the nacelle 3, and carries three wind turbine blades 5 projecting outwardly from the nacelle 3. While the example shown in FIG. 1 has three blades 5, it will be appreciated that other numbers of blades 5 are possible.

When wind blows against the wind turbine 1, the wind turbine blades 5 generate a lift force which causes a generator (not shown) within the nacelle 3 to generate electrical energy.

It will be appreciated that the wind turbine 1 depicted may be any suitable type of wind turbine 1. The wind turbine 1 shown is an upwind wind turbine, although it will be appreciated the wind turbine 1 may be a downwind wind turbine. The wind turbine 1 may be an onshore wind turbine such that the foundation is embedded in the ground, or the wind turbine 1 may be an offshore installation in which case the foundation would be provided by a suitable marine platform.

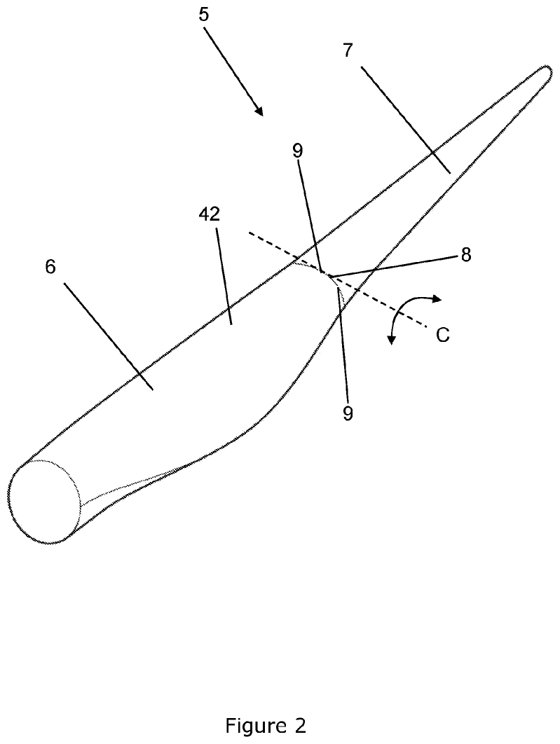

FIG. 2 shows an isometric view of one of the wind turbine blades 5.

The wind turbine blade 5 comprises an inboard wind turbine blade portion 6 and an outboard wind turbine blade portion 7 for joining together by a joint 8. Advantageously, providing the wind turbine blade 5 as two portions may help to simplify transport of the wind turbine blade 5, especially onshore.

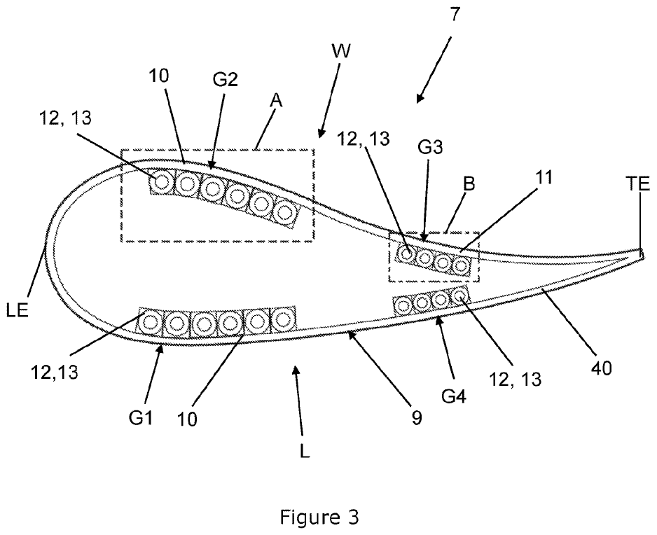

FIG. 3 shows a profile view of the end 9 of the outboard wind turbine blade portion 7. A corresponding profile view of the end 9 of the inboard wind turbine blade portion 6 may be a mirror image of the end 9 shown in FIG. 3 about a vertical plane. However, the end of the inboard wind turbine blade portion may have a different profile shape. In the following, anything discussed in relation to the end 9 of the outboard wind turbine blade portion 7 is applicable to the end 9 of the inboard wind turbine blade portion 6 unless stated otherwise.

Each of the inboard and outboard wind turbine blade portions 6, 7 has an end 9 with an aerofoil profile. The aerofoil profile has both convex and concave geometric portions 10, 11. The terms “concave” and “convex shape” are used in relation to the external geometry of the end 9, i.e. it is seen from a view point outside of the aerofoil profile so that the convex portion curves outwards and the concave portion curves inwards.

As shown in FIG. 3, the end 9 includes at least two convex geometric portions 10, and at least one concave geometric portion 11. Each respective wind turbine blade portion 6, 7 has a leading edge LE, a trailing edge TE, a leeward side L extending between the leading edge LE and the trailing edge TE and a windward side W extending between the leading edge LE and the trailing edge TE. The windward side W of the end 9 includes a convex portion 10 adjacent a concave portion 11 between the leading edge LE and the trailing edge TE of the blade portion 7. The leeward side L of the end 9 includes a convex portion 10 extending between the leading edge LE and the trailing edge TE. In alternative examples (not shown), the aerofoil profile of the ends 9 of the respective wind turbine blade portions 6, 7 may have any suitable aerofoil shape.

The end 9 of each of the respective wind turbine blade portions 6, 7 has a plurality of inserts 12 embedded therein. Each insert 12 comprises an end portion 13 having a connection for coupling the insert 12 to another of the inserts 12 across the joint 8.

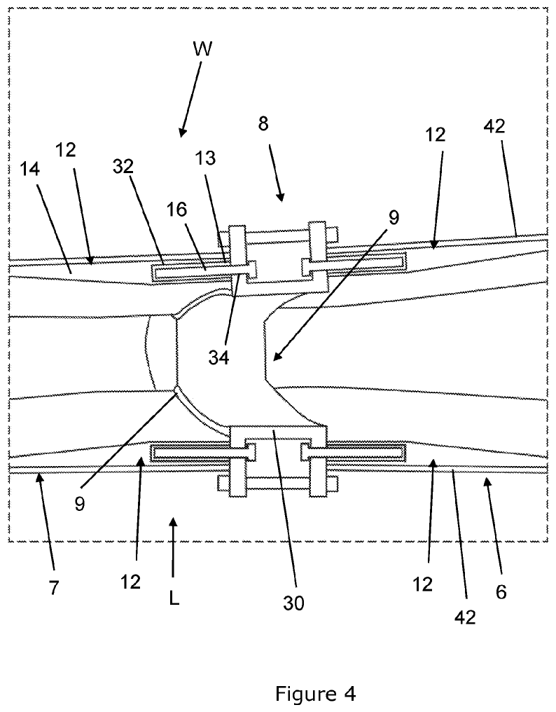

FIG. 4 shows a spanwise cross-sectional view through the wind turbine blade 5 shown in FIG. 2. Corresponding inserts 12 on the windward sides W of the ends 9 of the respective wind turbine blade portions 6, 7 are coupled to each other across the joint 8. Likewise, corresponding inserts 12 on the leeward sides L of the ends 9 of the respective wind turbine blade portions 6, 7 are coupled to each other across the joint 8. The end 9 of each of the respective wind turbine blade portions 6, 7 has an identical number of inserts 12. The inserts 12 each extend generally along a spanwise direction of the wind turbine blade 5.

The inboard wind turbine blade portion 6 and the outboard wind turbine blade portion 7 may be joined together by the joint 8. The joint 8 may comprise a joint member 30 between the inboard wind turbine blade portion 6 and the outboard wind turbine blade portion 7. The end portion 13 of at least one of the inserts 12 may have a bushing 32 with a threaded bore for receiving a threaded fastener 16. The threaded fastener 16 may form the connection for joining the wind turbine blade portions 6, 7 together.

In FIG. 4, each fastener 16 is received through a hole 34 in the joint member 30 and the bushing 32 of one of the inserts 12 to secure the insert 12 to the joint member 30. The joint member 30 is made of a metal, such as steel, via a casting process. In alternative examples, the joint member 30 may be made from any suitable material (such as fibre reinforced composite) via any suitable process. Advantageously, joining the inboard wind turbine blade portion 6 and the outboard wind turbine blade portion 7 together via the joint 8 enables the blade portions 6, 7 to be transported separately and assembled at the site of the wind turbine 1.

The plurality of inserts 12 may be sandwiched between fibre reinforced composite layers forming a shell 42 of the wind turbine blade 5 (such as shown in FIG. 4). The inserts may be bonded to the neighbouring fibre reinforced composite layers so as to transfer load between the insert and the fibre reinforced composite layers.

The plurality of inserts 12 of one of the respective wind turbine blade portions 6, 7 includes: at least one first insert 12a, and at least one second insert 12b. The first insert 12a has a geometry different than a geometry of the second insert 12b.

Each wind turbine blade portion may have only two different insert geometries, e.g. one or more first inserts having the same geometry and one or more second inserts having the same geometry, where the first and second inserts have different geometries.

Alternatively, each wind turbine blade portion may have three, four or more different insert geometries.

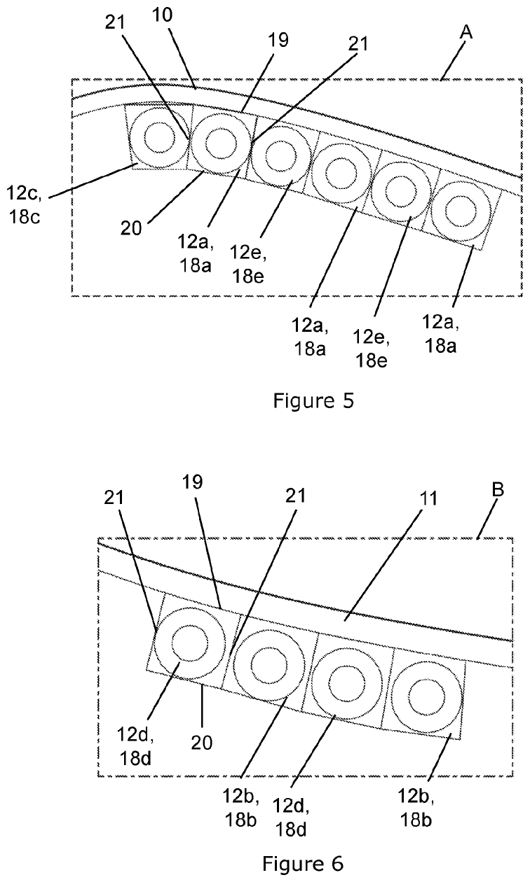

FIGS. 5 and 6 show magnified views of the areas A and B respectively shown in FIG. 3. The area A shows a convex portion 10 of the outer wind turbine blade portion 7. The area B shows a concave portion 11 of the outer wind turbine blade portion 7. As shown in FIGS. 5 and 6, the plurality of inserts 12 include first inserts 12a having the same geometry as each other; second inserts 12b having the same geometry as each other; third inserts 12c having the same geometry as each other; fourth inserts 12d having the same geometry as each other; and fifth inserts 12e having the same geometry as each other. The first 12a, second 12b, third 12c, fourth 12d and fifth 12e inserts all have different geometries relative to each other.

Advantageously, providing inserts 12 with different geometries may enhance packing of the inserts 12 within the convex 10 and concave portions 11 of each end 9 and may enable a stronger bonded connection between the inserts and the neighbouring fibre reinforced composite layers. For example, if the inserts of a wind turbine blade portion all have the same end portion cross section, e.g. trapezoidal, then the packing of the inserts around the circumference of the end of the blade portion will be compromised as the concave and convex geometry of the aerofoil profile changes around the circumference. This poor packing can lead to undesirable gaps between adjacent inserts, which can lead to undesirable resin pockets when the blade is infused with resin during manufacture using a vacuum assisted resin transfer moulding process for example. By providing at least two different insert geometries, the packing of the inserts can be improved, reducing these undesirable gaps between inserts and avoiding resin pockets which can lead to structural weakness and possibly pull out of the insert under high tensile load across the joint.

Advantageously, providing inserts 12 with different geometries may reduce the weight of the blade. For example, if the inserts of a wind turbine blade portion all have the same geometry then they need to be designed for the highest load transferred across the joint. In practice, different inserts will observe different loads across the joint, and so some inserts will be over engineered, adding weight and cost. By providing at least two different insert geometries, the inserts around the circumference of the end of the blade portion can be tailored to the local loads, which may provide cost and weight saving.

Advantageously, providing inserts 12 with different geometries may enable the joint to be constructed without impacting on the outer aerofoil profile of the end of the blade portion at the joint. For example, if the inserts of a wind turbine blade portion all have the same geometry then their dimension may be constrained by the space available, especially at the trailing edge of the blade portion, or else the outer aerofoil profile of the end of the blade portion may need to be altered to accommodate the inserts. This may undesirably impact the aerodynamic performance of the blade and may require a fairing to provide a smooth outer aerodynamic surface. By providing at least two different insert geometries, the inserts around the circumference of the end of the blade portion can be tailored to the local loads, and the local space available within the blade aerofoil profile, so that all inserts can fit within the blade aerofoil profile, which may provide aerodynamic performance enhancements.

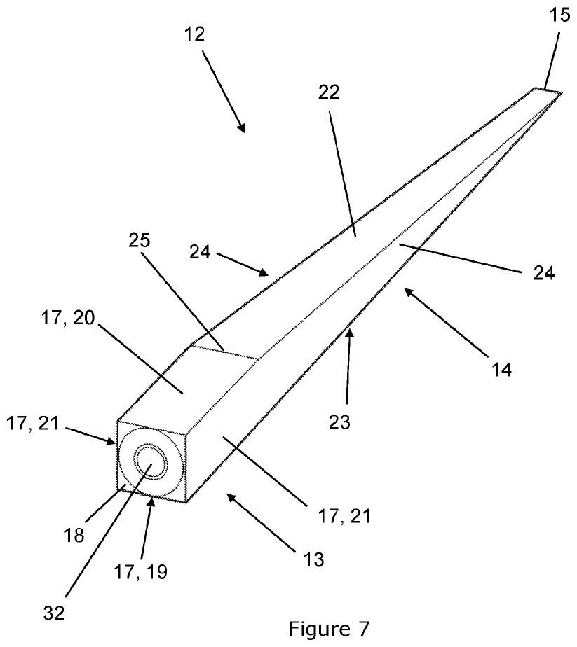

FIG. 7 shows an isometric view of one of the inserts 12.

Each insert 12 comprises an extension portion 14 which extends away from the end portion 13 to a tip 15. The extension portion may provide a large surface area for transferring load between the insert and the fibre reinforced composite layers. This aids in preventing pull out of the insert under high tensile load across the joint.

In FIG. 7, the extension portion 14 tapers width-wise from the end portion 13 to the tip 15, which aids in smoothly transferring load between the insert 12 and the fibre reinforced composite layers, avoiding stress concentrations. This aids in preventing pull out of the insert under high tensile load across the joint. The extension portion 14 may taper from the end portion 13 to the tip 15 such that the tip is nearest the periphery of the blade aerofoil profile, i.e. the taper of the extension portion 14 is towards the periphery of the blade aerofoil profile. Alternatively, the tip 15 may lie near a mid-plane of the insert or may lie furthest from the periphery of the blade aerofoil portion. The tip position may be the same for all inserts arranged around the circumference of the aerofoil profile.

Each insert 12 may have an end portion 13 with peripheral faces 17 which define a cross-section 18. The peripheral faces 17 of each of the plurality of inserts 12 may include an end portion inner face 20 orientated towards an interior of the wind turbine blade portion 6, 7, an end portion outer face 19 orientated towards an exterior of the wind turbine blade portion 6, 7, and a pair of end portion side faces 21. The end portion outer face may be wider or narrower or the same width as the end portion inner face Each end portion side face 21 may be a substantially planar facet. Advantageously, this helps to reduce gaps between adjacent inserts 12.

The extension portion 14 of each of the plurality of inserts 12 may include an extension portion inner face 22 orientated towards an interior of the wind turbine blade portion 6, 7, an extension portion outer face 23 orientated towards an exterior of the wind turbine blade portion 6, 7, and a pair of extension portion side faces 24. The extension portion inner face 22 may meet with the end portion inner face 20. The extension portion outer face 23 may meet with the end portion outer face 19. The extension portion side faces 21 may meet with the end portion side faces 24. A height between the extension portion inner face 22 and the extension portion outer face 23 may reduce (e.g. uniformly) as it extends away from the end portion 13. The extension portion inner face 22 and/or the extension portion outer face 23 may be planar.

The extension portion inner face 22 and one of the extension portion side faces 24 are visible in the view shown in FIG. 7, in which the extension portion outer face 23 and the other extension portion side face 24 are indicted via arrows. The extension portion inner face 22 is arranged at a non-zero angle to the end portion inner face 20 (i.e. they are non-parallel). The extension portion inner face 22 meets the end portion inner face 20 at an edge 25. As shown in FIG. 4, the extension portion outer face 23 and the end portion outer face 19 are coplanar. The extension portion inner face 22 is angled relative to the extension portion outer face 23 such that the height therebetween reduces uniformly as the extension portion 14 extends away from the end portion 13. The extension portion inner face 22 and the extension portion outer face 23 meet at the tip 15.

The peripheral faces 17 of the first insert 12a may define a first cross-section 18a (FIG. 5). The peripheral faces 17 of the second insert 12b may define a second cross-section 18b (FIG. 6). The first cross-section 18a may have a geometry different than a geometry of the second cross-section 18b. The first and/or second cross-sections 18a, 18b may be generally quadrilateral. For example, the first and/or second cross-sections 18a, 18b may be generally trapezoidal, rectangular or square.

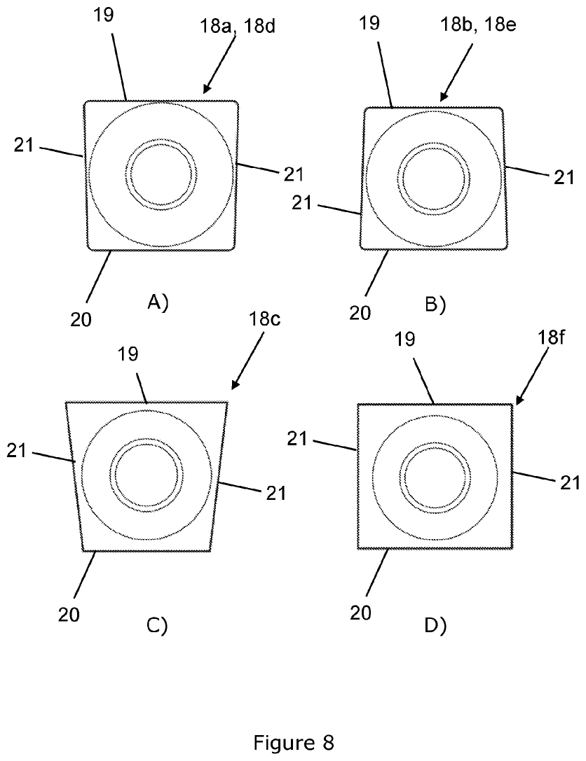

FIGS. 8A-8D show four examples of inserts 12 having end portion cross-sections 18 with different geometries. FIG. 8A shows a trapezoidal shape of the first cross-section 18a of each first insert 12a, which is identical to the shape of a fourth cross-section 18d of each fourth insert 12d. The geometries of the first and fourth inserts 12a, 12d differ in their size. FIG. 8B shows a trapezoidal shape of the second cross-section 18b of each second insert 12b, which is identical to the shape of a fifth cross-section 18e of each fifth insert 12e. The geometries of the second and fifth inserts 12b, 12e differ in their size. FIG. 8C shows a trapezoidal shape of a third cross-section 18c of each third insert 12c. FIG. 8D shows an example rectangular cross-section 18f for an insert 12, (which may alternatively be present in the wind turbine blade 5 of FIGS. 2 to 6).

The geometries of the first cross-section 18a and the fifth cross-section 18e differ in their orientations. In particular, the geometry of the first cross-section 18a corresponds to the geometry of the fifth cross-section 18e rotated through 180 degrees. Likewise for the second cross-section 18b and the fourth cross-section 18d. Advantageously, as shown in FIGS. 5 and 6, arranging the inserts 12 side-by-side with cross-sections 18 having geometries alternating between that of FIGS. 8A and 8B helps to minimise gaps between the inserts 12 along both convex 10 and concave 11 portions of the aerofoil profile present on the same side (windward or leeward) of the blade. The first and first cross-sections 18a, 18b may differ only in their orientation which is measured relative to the periphery of the blade aerofoil profile.

The trapezoidal shape of the cross-section 18c in FIG. 8C has a higher ratio between the widths of the outer and inners faces 19, 20 relative to the trapezoidal first cross-section 18a, and thus has a different geometry thereto.

In alternative examples (not shown), the first and/or second cross-sections 18a, 18b may have any suitable generally quadrilateral shape.

At least one of the plurality of inserts 12 may have a size different than a size of another of the plurality of inserts 12. The first cross-section 18a may be larger than the second cross-section 18b.

As shown in FIGS. 3, 5 and 6, the first cross-section 18a of the first inserts 12a within the area A may be larger than the cross-section 18b of the second inserts 12b within the area B. Moreover, the cross-section 18 of all of the inserts 12 within the area A may be larger than all of the inserts within the area B. Providing the inserts 12 in the area B with relative smaller cross-sections 18, enables these inserts 12 to be located closer to the trailing edge TE, which aids in transferring loads between the trailing edges TE of the respective wind turbine blade portions 6, 7.

Additionally or alternatively, at least one of the plurality of inserts 12 may be longer (in a blade spanwise direction), wider (in a blade chordwise cross section circumferential direction) and/or thicker than another of the plurality of inserts 12. As shown, the inserts 12 have a single bushing 32, but the one or more of the inserts may comprise a plurality of bushings. For example, a wider and/or thicker insert may comprise two or three bushings.

The plurality of inserts 12 may be arranged side by side around at least a portion of the circumference of the aerofoil profile at the end 9 of the respective wind turbine blade portion 6, 7. Adjacent peripheral faces 17 of adjacent inserts 12 may be oriented normal to the circumference of the aerofoil profile at the end 9 of the respective wind turbine blade portion 6, 7.

In FIGS. 3, 5 and 6, the end portion side faces 21 of adjacent inserts 12 are oriented normal to the circumference of the aerofoil profile. Advantageously, this helps to minimise gaps between adjacent inserts 12 along concave 10 and convex portions 11 of the aerofoil profile, enhancing the strength and rigidity of the coupling between the wind turbine blade portions 6, 7. In alternative examples (not shown), adjacent peripheral faces 17 of adjacent inserts 12 may be oriented at any suitable angle to the circumference of the aerofoil profile at the ends 9.

In FIGS. 3, 5 and 6, the end portion side faces 21 of adjacent inserts 12 may be closely adjacent but not in contact with each other so there may be gaps between the end portion side faces 21 of at least two adjacent inserts 12. The gaps are preferably narrow gaps. This allows infusion of resin between the inserts to bond the inserts together during manufacture of the blade, e.g. by vacuum assisted resin transfer moulding. Material, such as glass fabric may be placed in these gaps to assist resin infusion. Spacer material, such as core material, could also be placed between adjacent inserts.

The plurality of inserts 12 may be provided in groups, with a first group of inserts G1 near the on the leeward side L near a thickest part of the aerofoil profile, a second group of inserts G2 on the windward side W near the thickest part of the aerofoil profile, a third group of inserts G3 near the trailing edge TE on the windward side W and a fourth group of inserts G4 near the trailing edge TE on the leeward side L. The first and second groups of inserts may connect to main spar caps which extend spanwise along the blade near the thickest part of the aerofoil profile. The third and fourth groups of inserts may connect to trailing edge spar caps or stringers which extend spanwise along the blade near the trailing edge.

FIG. 3 shows the four groups of inserts G1, G2, G3, G4. The inserts 12 within each group are arranged side-by-side along the circumference of the aerofoil profile of the end 9. The groups G1, G2, G3, G4 are spaced from each other along the circumference of the aerofoil profile of the end 9. The first and second groups G1, G2 each include six inserts 12, but may include more or fewer. The third and fourth groups G3, G4 each include four inserts 12, but may include more or fewer. Advantageously, providing the inserts 12 in such groups helps to minimise the number of inserts 12, since the inserts 12 may be located in the portions of the respective wind turbine blade portions 6, 7 which experience the greatest loads (e.g. bending and torsional) during operation.

The plurality of inserts 12 may be provided in one, two, three or more than four groups of inserts having the same geometry.

The inserts 12 of the first and/or second groups of inserts G1, G2 may have a greater depth between their end portion inner face 20 and their end portion outer face 19 than the inserts 12 of the third and/or fourth groups of inserts G3, G4.

As shown in FIG. 3, the inserts 12 of the first and second groups of inserts G1, G2 have a greater depth between their end portion inner face 20 and their end portion outer face 19 than the inserts 12 of the third and fourth groups of inserts G3, G4. Advantageously, providing the inserts 12 of the third and fourth groups G3, G4 with a reduced depth enables these inserts 12 to be located closer to the trailing edge TE whilst maintaining a space between the third and fourth groups G3, G4.

At least one of the plurality of inserts 12 may have a bushing with a threaded bore diameter different than a threaded bore diameter of another of the plurality of inserts 12.

The inserts 12 in the third and fourth groups G3, G4 may have bushings 32 with threaded bores, such as shown in FIG. 3, and having a smaller diameter relative to the inserts 12 in the first and second groups G1, G2. Advantageously, this enables smaller, and thus lower mass, fasteners 16 to be used to couple the inserts 12 in the third and fourth groups G3, G4 to corresponding inserts 12 across the joint 8. Moreover, this enables larger fasteners 16 to be used to couple the inserts in the first and second groups G1, G2, which are located in regions of the wind turbine blade portions 6, 7 that may be subjected to higher loads.

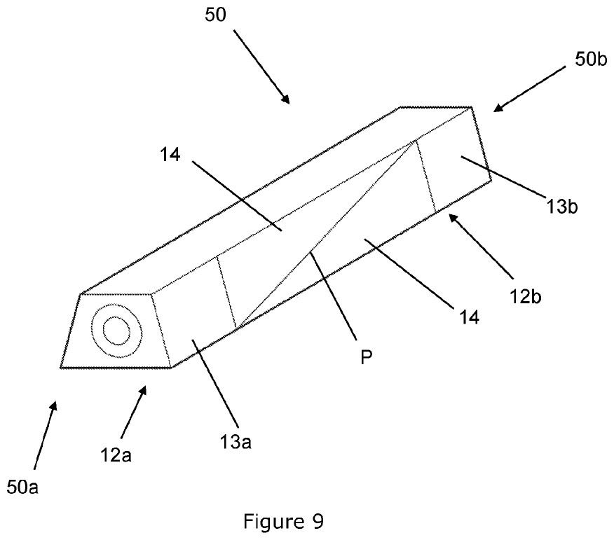

FIG. 9 shows an exemplary blank body 50 for forming first and second inserts 12a, 12b.

The first insert 12a and the second insert 12b may be formed from the single blank body 50. The first insert 12a and the second insert 12b may be formed via cutting of the blank body 50 along a plane P of the blank body 50. The blank body 50 may include the end portion 13a of the first insert 12a at a first end 50a of the blank body 50, and the end portion 13b of the second insert 12b at an opposed second end 50a of the blank body 50. The cutting plane P may extend diagonally across the blank body 50. The cutting plane P may extend from the end portion 13a of the first insert 12a at a first surface of the blank body 50, to the end portion 13b of the second insert 12b at an opposed second surface of the blank body 50. A cross-section of the first end 50a of the blank body 50 may be identical to a cross-section of the second end 50b of the blank body 50.

As shown in FIG. 9, cutting of the blank body 50 along the plane P forms the extension portions 14 of the first and second inserts 12a, 12b. Forming the first and second inserts 12a, 12b from the blank body 50 provides two inserts 12 having end portions 13 with cross-sections 18 having different geometries. In particular, the geometry of the cross-section 18 of the first insert 12a corresponds to the geometry of the cross-section 18 of the second insert 12b rotated through one hundred and eighty degrees. For example, such as the first and fifth inserts 12a, 12e, or the second and fourth inserts 12b, 12d in FIGS. 3, 5 and 6. Advantageously, forming two inserts 12 via the blank body 50 simplifies manufacture of the inserts 12.

The blank body 50 may comprise two bushings 32 encased in a composite material (e.g. a glass-reinforced composite material). The bushings 32 may be made from a metal material, such as steel.

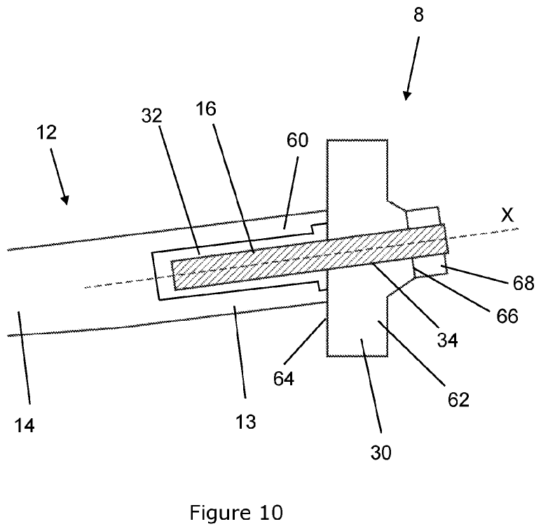

As shown in FIGS. 2 and 3, the shell 42 of the wind turbine blade 50 has a spanwise taper in blade chord and blade thickness. The inserts 12, which extend along the spanwise direction of each wind turbine blade portion 6, 7, follow the tapering geometry of the shell 42 so as to transfer the loads acting on the shell 42 to the joint 8. Due to the spanwise taper in blade chord and blade thickness, the inserts 12 and the corresponding fasteners 16 on either side of the joint 8 will not be perpendicular to the joint 8. FIG. 10 shows an example of a connection between one of the inserts 12 and the joint member 30 of the joint 8.

The end portion 13 of at least one of the inserts 12 may have a bushing 32 with a threaded bore which receives a threaded fastener 16 projecting from an end face 60 of the insert 12 opposite the tip 15. The joint member 30 may have a flange 62 with a first face 64 and a second face 66 opposing the first face 64. The flange 62 may have a through hole 34 between the first face 64 and the second face 66. The first face 64 may abut the end face 60 of the insert 12. The first and second faces 64, 66 of the joint member 30 may be non-parallel such that the second face 66 is normal to a longitudinal axis X of the threaded fastener 16.

As shown in FIG. 10, the fastener 16 and the insert 12 are secured to the joint member 30 via a nut 68 tightened onto a free end of the fastener 16 proud of the second face 66. Since the second face 66 is normal to the longitudinal axis X of the fastener 16, the nut 68 can make even contact with the second face 66. Advantageously, this minimises bending stresses in the fastener 16 when the fastener 16 is preloaded via the nut 68. The joint member 30 includes a plurality of the flanges 62, corresponding to the number of inserts 12.

With reference to FIG. 4, it is beneficial to provide the threaded fasteners 16 with as large a cross-sectional area as possible so that a high preload can be applied to the fasteners 16 by the nuts 68. However, during operation of the wind turbine 1, the threaded fasteners 16 are subjected to bending stresses caused by bending of the wind turbine blade 5. As such, in this regard, it is beneficial to reduce the cross-sectional area of the fasteners 16, especially the middle portion of the fastener 16 away from its threaded ends, to reduce the bending stresses.

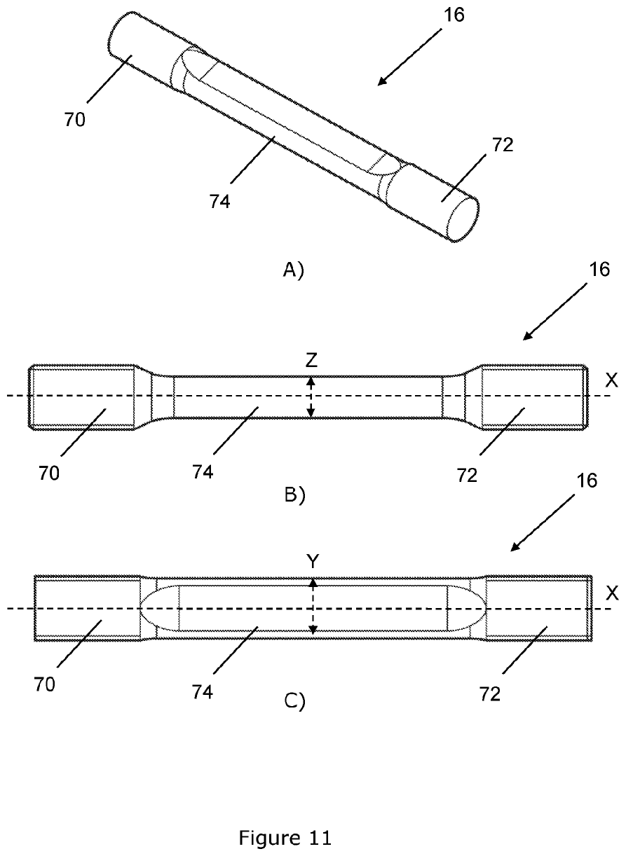

FIGS. 11A-C show an example of one of the threaded fasteners 16. FIG. 11A shows an isometric view of the threaded fastener 16. FIG. 11B shows a profile view of the threaded fastener 16. FIG. 11C shows a plan view of the threaded fastener 16.

The threaded fastener 16 may have a first threaded end 70 received in the threaded bore of the insert 12, a second threaded end 72 for receiving a nut 68, and a shank 74 between the first threaded end 70 and the second threaded end 72. The shank 74 may have a solid non-circular cross-section with a major dimension Y generally aligned with a circumference of the end 9 of the respective wind turbine blade portion 6, 7, and a minor dimension Z generally perpendicular to the major dimension Y.

As shown in FIGS. 11B and 11C, the major and minor dimensions Y, Z are perpendicular to the longitudinal axis X of the fastener 16.

With further reference to FIG. 2, the wind turbine blade 5 is predominantly subjected to bending loads about a chordwise axis C of the blade 5. Therefore, by aligning the major dimension Y with the circumference of the end 9 of the respective wind turbine blade portion 6, 7, the fastener 16 bends predominantly about an axis thereof aligned with the major dimension Y. Since the minor dimension is generally perpendicular to the major dimension Y, the bending stresses of the fastener 16 are reduced, whilst maintaining a large cross-sectional area of the fastener 16 for high preloading.

Although the invention has been described above with reference to one or more preferred embodiments, it will be appreciated that various changes or modifications may be made without departing from the scope of the invention as defined in the appended claims.

1. A wind turbine blade comprising an inboard wind turbine blade portion and an outboard wind turbine blade portion for joining together by a joint, each of the inboard and outboard wind turbine blade portions having an end with an aerofoil profile, wherein the aerofoil profile has both concave and convex geometric portions, the end of each of the respective wind turbine blade portions having a plurality of inserts embedded therein, each insert comprising an end portion having a connection for coupling the insert to another of the inserts across the joint and an extension portion which extends away from the end portion to a tip, wherein the plurality of inserts of one of the respective wind turbine blade portions includes:
at least one first insert; and
at least one second insert,
wherein the first insert has a geometry different than a geometry of the second insert.

2. The wind turbine blade according to claim 1, wherein each insert has an end portion with peripheral faces which define a cross-section, wherein the peripheral faces of the first insert define a first cross-section, and the peripheral faces of the second insert define a second cross-section, and wherein the first cross-section has a geometry different than a geometry of the second cross-section.

3. The wind turbine blade according to claim 1, wherein the first and/or second cross-sections are generally quadrilateral, and preferably, wherein the first and/or second cross-sections are generally trapezoidal, rectangular or square.

4. The wind turbine blade according to claim 2, wherein the first cross-section is larger than the second cross-section.

5. The wind turbine blade according to claim 2, wherein the peripheral faces of each of the plurality of inserts include an end portion inner face towards an interior of the wind turbine blade portion, an end portion outer face towards an exterior of the wind turbine blade portion, and a pair of end portion side faces.

6. The wind turbine blade according to claim 5, wherein each end portion side face is a substantially planar facet.

7. The wind turbine blade according to claim 5, wherein the extension portion of each of the plurality of inserts includes an extension portion inner face towards an interior of the wind turbine blade portion, an extension portion outer face towards an exterior of the wind turbine blade portion, and a pair of extension portion side faces; and wherein the extension portion inner face meets with the end portion inner face, the extension portion outer face meets with the end portion outer face, and the extension portion side faces meet with the end portion side faces; and wherein a height between the extension portion inner face and the extension portion outer face reduces as it extends away from the end portion.

8. The wind turbine blade according to claim 2, wherein adjacent peripheral faces of adjacent inserts are oriented normal to the circumference of the aerofoil profile at the end of the respective wind turbine blade portion.

9. The wind turbine blade according to claim 1, wherein the plurality of inserts are arranged side by side around at least a portion of a circumference of the aerofoil profile at the end of the respective wind turbine blade portion.

10. The wind turbine blade according to claim 1, wherein each respective wind turbine blade portion has a leading edge, a trailing edge, a leeward side extending between the leading edge and the trailing edge and a windward side extending between the leading edge and the trailing edge, wherein the plurality of inserts are provided in groups, with a first group of inserts on the leeward side near a thickest part of the aerofoil profile, a second group of inserts on the windward side near the thickest part of the aerofoil profile, a third group of inserts near the trailing edge on the windward side and a fourth group of inserts near the trailing edge on the leeward side.

11. The wind turbine blade according to claim 10, wherein the peripheral faces of each of the plurality of inserts include an end portion inner face towards an interior of the wind turbine blade portion, an end portion outer face towards an exterior of the wind turbine blade portion, and a pair of end portion side faces, and wherein the inserts of the first and/or second groups of inserts have a greater depth between their end portion inner face and their end portion outer face than the inserts of the third and/or fourth groups of inserts.

12. The wind turbine blade according to claim 1, wherein the end portion of at least one of the inserts has a bushing with a threaded bore for receiving a threaded fastener.

13. The wind turbine blade according to claim 12, wherein the threaded fastener forms the connection for joining the wind turbine blade portions together.

14. The wind turbine blade according to claim 12, wherein at least one of the plurality of inserts has a threaded bore diameter different than a threaded bore diameter of another of the plurality of inserts.

15. The wind turbine blade according to claim 1, wherein the plurality of inserts are sandwiched between fibre reinforced composite layers forming a shell of the wind turbine blade.

16. The wind turbine blade according to claim 1, wherein the inboard wind turbine blade portion and the outboard wind turbine blade portion are joined together by a joint;
wherein the joint comprises a joint member between the inboard wind turbine blade portion and the outboard wind turbine blade portion,
wherein the end portion of at least one of the inserts has a bushing with a threaded bore which receives a threaded fastener projecting from an end face of the insert opposite the tip, and the joint member has a flange with a first face and a second face opposing the first face and a through hole between the first face and the second face,
wherein the first face is abutting the end face of the insert, and the first and second faces of the joint member are non-parallel such that the second face is normal to a longitudinal axis of the threaded fastener.
